(19) United States
(12) Patent Application Publication
(10) Pub. No.: US 2007/0027792 A1
(43) Pub. Date: Feb. 1, 2007

(54) Online auction system

(76) Inventor: Charles Smith, Carlyle (CA)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 11/192,924

(22) Filed: Jul. 29, 2005

(51) Int. Cl. G06Q 40/00

(52) U.S. Cl. 705/37

(57) ABSTRACT

An online auction system and method that incorporates deposits into an auction model is disclosed. Remote terminals operated by potential bidders and sellers are used to access an auction server over a network. The auction server determines a deposit submitted in conjunction with an item to be auctioned by a seller and displays the amount of the deposit to potential bidders viewing an auction item record corresponding to the item. The auction server requires bidders to have submitted a sufficient deposit before a bid on an item up for auction will be registered by the auction server. If the bidder should win the auction, but fails to submit a complete payment for the item, the deposit will be forfeited and divided in a predetermined way. If the seller fails to complete the transaction, the seller's deposit is forfeited and divided in a predetermined way.

### BACKGROUND

Online auctions over the internet have proven to be very popular. Using an auction format to sell an item as opposed to a fixed price sales regime has the advantage of quickly being able to establish a reliable equilibrium between the supply of an item, the demand for that item and the price of the item. It allows the seller to avoid having to predetermine (often arbitrarily) a price to ask for an item that he wants to sell, and usually results in faster sales. With the advent of the Internet, conducting an auction in an online setting has greatly expanded the scope of auctions. Conducting an auction over the internet has the potential to greatly expand the number of potential purchasers for an auctioned item because the pool of potential bidders for an online auction is exponentially larger than it ever could have been with traditional live auctions. Online auctions also allow an enormously expanded range of products to be offered for sale to any particular buyer because of the potentially exponentially larger pool of sellers. This results in the opportunity to find, on the one hand, the best price in the world for common items, as well as on the other hand the opportunity to find for sale items which may be unique or extremely rare in the world.

Problems, however, arise in translating the traditional live auction format to the Internet environment. The most profound of these problems arise out of the fact that the remoteness and anonymity of the Internet environment make it difficult to impose negative consequences on bidders and sellers for not adhering to standard honorable practices of commerce. Some attempts have been made to change the traditional auction model to make it finction better in the Internet environment with moderate success. However, several outstanding problems have not been sufficiently addressed. The most flagrant of these are: shill bidding, which consists of sellers bidding on their own auctions to raise the price artificially; bid shielding, which consists of bidders bidding very low at the very outset of an auction, then immediately bidding very high, discouraging any other bid, only to withdraw their very high bid at the very end of the auction to expose the very low bid to win the auction; non delivery by the seller of the item sold at auction, or delivery by the seller of an item that is not the item listed for sale; non-completion of payment by the winning bidder in an auction which necessitates reselling of the item; an online escrow system that does not prevent the receiver of an item shipped to him from absconding with the item, and claiming that the legitimate item that was shipped to him was not the item that he purchased; and an online escrow service that does not prevent a shipper from shipping a worthless item and claiming that the receiver has rejected it on frivolous grounds.

### SUMMARY OF THE INVENTION

It is an object of the present invention to provide a method and apparatus that overcomes the disadvantages of the prior art. It is a further object of the present invention to provide an online auction apparatus and method that addresses problems with prior art online auction systems. It is a further object of the present invention to provide an online auction system and method that prevents, or mitigates the effects of, users of the online auction system attempting to circumvent or ignore the auction service rules.

The invention provides, in one embodiment of the invention, a system for conducting online auctions over a computer network. The system comprises: an auction server, the auction server containing: a bidder database containing at least one bidder record associated with a corresponding bidder, wherein each bidder record includes a deposit amount which represents the amount of a deposit paid by that bidder; and an item database containing at least one item record associated with an item to be auctioned; and at least one remote terminal operatively connected to the auction server over the network, each remote terminal operative to allow a bidder to transmit a bid to the auction server. The auction server, in response to receiving a bid from a remote terminal by a bidder during an auction of an item, checks the deposit amount in the bidder record associated with that bidder against a minimum required deposit in respect of the item being auctioned and if it is determined that a sufficient deposit has been paid by the bidder the auction server registers the current bid.

The invention provides, in a second embodiment, a method of conducting online auctions over a computer network, where remote terminals of potential bidders are used to access an auction server computer. The method comprises: receiving a deposit from a current bidder and storing the amount of the deposit as a deposit amount; receiving a current bid from the current bidder on an item being auctioned; in response to receiving the current bid, checking the deposit amount of the current bidder; and if the deposit amount of the current bidder indicates at least a minimum required deposit amount in respect of the item being auctioned, accepting and registering the current bid; and upon the occurrence of a predetermined auction closing condition, completing the auction of the item in accordance with auction rules based on the accepted bids in respect of the item.

The invention provides in a third embodiment, a system for conducting online auctions over a computer network. The system comprising: an auction server, the auction server containing an item database containing at least one item record associated with an item to be auctioned; a seller database containing at least one seller record associated with a seller of items contained in the item database; and at least one remote terminal operatively connected to the auction server over the network, each remote terminal operative to allow a seller to send the particulars of an item to be auctioned, including submitting a seller deposit in respect of that item, to the auction server resulting in the creation of an item record in the item database; wherein during an auction of an item from the item database by the auction server, the seller deposit amount in respect of the item being auctioned is displayed to potential bidders using remote terminals to access the auction server to participate in the auction.

The invention provides in a fourth embodiment, a method of conducting auctions over a network, where remote terminals of potential bidders and potential sellers are used to access an auction server computer. The method comprises; the auction server receiving a posting of an item to be auctioned and a. seller deposit and creating an auction item record associated with the item and storing a seller deposit amount in the current auction item record; allowing a potential bidder using a remote terminal to access the auction item record associated with the item and viewing the seller deposit amount; the auction server receiving a current bid on the item from a current bidder and in response to receiving the current bid, checking a bidder deposit amount in a bidder record associated with the current bidder and registering the current bid if the bidder deposit amount is at least a minimum required deposit amount in respect of the item being auctioned; and upon an occurrence of a predetermined auction closing condition, completing the auction of the item in accordance with a set of auction rules based on the accepted bids in respect of the item.

The invention provides an online auction system and method that institutes a penalty/award system that encourages users of the system to comply with auction service rules. The invention penalizes non-compliance with the rules while at the same time rewarding those parties most injured by said non-compliance. By incorporating a system of deposits for bidders and sellers into the standard English (Or ascending) auction model, the present invention provides an auction service with a leverage mechanism to encourage bidders and sellers to comply with the rules of the online auction service. The deposit system requires bidders to submit a deposit before a bid on an item up for auction will be accepted and registered by the auction system. If the bidder should win the auction on which he or she has bid, but fails to follow through with payment for said item, his or her deposit will be forfeited and divided in a predetermined way. If the seller fails to ship the item which he has sold at auction within a predetermined time from the auction service receiving payment for said item, that seller forfeits his deposit, and that deposit is divided in a predetermined way, that is known to all participants in the auction, between the winning bidder and the second highest bidder.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a block diagram showing an exemplary online auction system with which the present invention may operate;

FIG. 2 is a flowchart of a method for a seller to submit an item for auction in accordance with the present invention;

FIG. 3 is a flowchart of a method for a bidder to submit a bid on an auction item in accordance with the present invention;

FIG. 4 is a flowchart of a method of completing an auction transaction after the auction is completed and the item is shipped to the bidder after the bidder submits the proper payment in accordance with the present invention; and

FIG. 5 is a flowchart of a method of completing an auction transaction after the auction is completed and the item is shipped to the bidder COD in accordance with the present invention.

### DETAILED DESCRIPTION OF THE ILLUSTRATED EMBODIMENTS

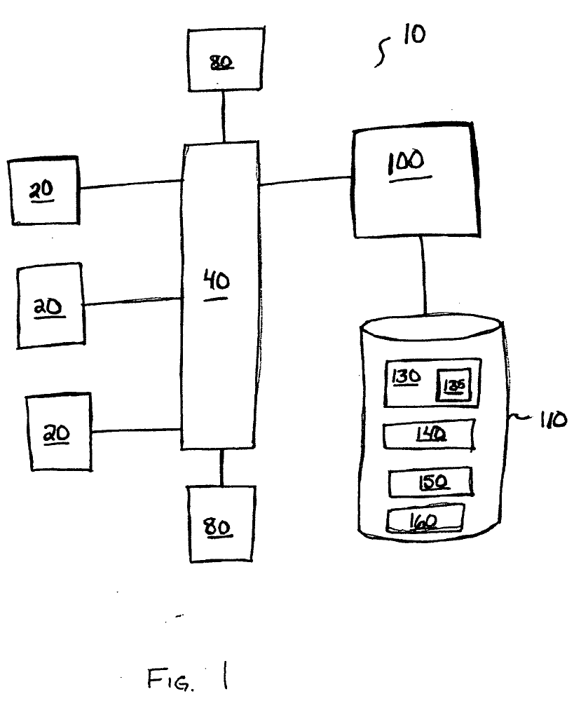

FIG. 1 is a typical online auction system 10 in which the present invention may be used. This typical online auction system 10 comprises a plurality of remote terminals 20 operatively connected over a network 40 to at least one auction server 100. Each remote terminal 20 is operative to communicate information inputted on the remote terminal 20 over the network 40 to the auction server 100.

Optionally, at least one shipper server 80 could be operatively connected to the remote terminals 20 and the auction server 100 through the network 40. This shipper server 80 would be operative to arrange shipment and track the shipments and communicate the tracking information to the remote terminals 20 and the auction server 100.

The auction server 100 would handle the operation of the online auction and coordinate a plurality of individual auctions. The auction server 100 also coordinates communications between the remote terminals 20. As is well known in the art, the auction server 100 could comprise a number of individual servers, whereby additional servers could be added to the auction server 100 to increase the capacity of the online auction and make the auction server 100 scalable.

Typically, the auction server 100 is connected to an auction database 110. Information necessary to conduct the plurality of auctions would be stored in this auction database 110. Typically the auction database 110 would comprise: bidder records 130; seller records 140; auction item records 150; and shipper rate databases 160 from various shippers around the world.

The bidder records 130 contain information the auction server 100 requires about a bidder in order to allow the bidder to bid on items that are up for auction and include a bidder's current deposit amount 135. The seller records 140 contain information the auction server 100 requires about a seller in order to allow the seller to post items for sale by auction on the auction system 140. Although the seller records 140 and bidder records 130 are shown separate in FIG. 1, it would be readily understood by someone in the art that a user could be both a seller and a bidder and therefore a user's seller record 140 and bidder record 130 could be stored as one record.

The auction item records 150 contain information about items that are being sold at auction and would typically be posted on a screen that would be available to be viewed by any potential bidder.

The shipper rate databases 160 contain all the shipping rates from any particular shipping point from which any particular shipper will ship to any particular destination to which that shipper will ship. These shipper rate databases 160 would be accessible by any potential bidder from a link on the screen that displays the auction item record 150 in order that that bidder be able to precisely calculate the shipping costs associated with any item on which that bidder may wish to bid.

Seller Posting Item for Auction

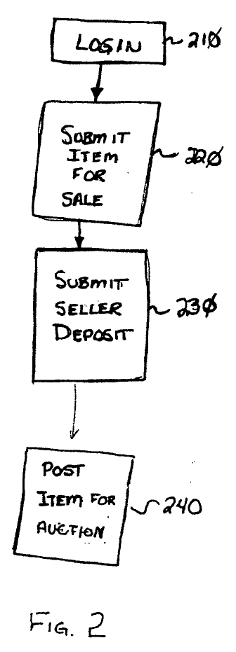

FIG. 2 illustrates a flow chart of a method for a seller to post an item for sale on the auction system 10. The method begins with the seller accessing the auction system 10 through a remote terminal 20. Once the seller has used the remote terminal 20 to connect to the auction server 100 over the network 40, the auction server 100 will prompt the seller to login 210 to the auction server 100. If the seller has already registered with the auction server 100, the login 210 involves the seller communicating identifying information to the auction server 100, typically in the form his name, a credit card number or portion thereof registered to him and the billing address associated with that credit card number and an e-mail address, from the remote terminal 20 to the auction server 100. The auction server 100 can then locate the seller record 130 in the auction database 120 that corresponds to the particular seller using the identifying information the seller provided to the auction server 100 during the login 310.

If the seller has not previously registered with the auction server 100, the login 210 would typically involve the seller registering with the auction server 100 so that the auction server 100 can create a seller record 140 corresponding to the seller in the auction database 110.

Typically, the first step of the registration process would involve the prospective registrant being shown an auction user agreement, which could be identical to the auction user agreement shown to prospective bidders. When reading the auction service user agreement, the seller will have the option of accessing a detailed explanation of why any particular clause of the user agreement is designed the way that it is designed; typically by clicking on an onscreen button at the end of each clause labeled “WHY”. In this manner, the rationale behind unique features of the auction system 10 can be fully explained to the new seller.

Once the seller has read and confirmed agreement with, the user agreement, the seller would register with the auction server 100, so that the auction server 100 can create a seller record 140 in the auction database 100 for that particular seller. This information could include: the seller's name, a physical address from where any item sold on the auction service will be shipped, a physical address to where any items that have been rejected by a bidder might be returned, credit card information, including at least one credit card number and the billing address that corresponds to that credit card number, the seller's email address, any other electronic communication means whereby a bidder may contact the seller to ask questions relating to the item up for auction, a screen name that the seller would like shown in conjunction with the auction, and/or any other information that might be needed to create a seller record 140 for that particular seller. With this information the auction server 100 could create a seller record 140 for that particular seller.

In one embodiment of the invention, the auction server 100 will attempt to screen out sellers who try to re-register on the auction system 10 using a different name to avoid the negative consequences of their poor past conduct. In this embodiment when a seller logs in 210 to the auction system 10 and registers with the auction server 100, the auction server 100 will search the seller records 140 and the bidder records 130 for any matches between the credit card billing address of the new registrant and the credit card billing address of any previous registrant. If a match is found, the prospective new registrant will be prevented from registering with the auction server 100.

Once the seller has successfully completed the login 210, the seller can then submit an item for sale 220. Typically submitting an item for sale 220 includes the seller communicating item information about the item for sale from the remote terminal 20 over the network 40 to the auction server 100. The auction server 100 would then save this item information in an auction item record 150 in the auction database 110.

Typically, this item information would comprise a picture of the item and a written description of the item. This item information could also comprise a minimum reserve amount the seller requires before the item can be sold.

The auction item record 150 can also include an e-mail address or other electronic communication means whereby any bidder on the item for sale can contact the seller to ask the seller questions regarding any aspect of the item for sale. If a bidder makes such a contact, the seller would have a predetermined amount of time i.e.—forty-eighty hours, to respond to such a query at the risk of forfeiting a predetermined portion of the seller's deposit.

At the time the seller submits an item for sale 220, the auction server 100 can allow the seller to specify the time and date when the auction begins, and a time and date when the auction will end. This information would then be stored by the auction server 100 in the auction item record 150 in the auction database 110.

When the seller submits the item for sale 220, the item information transferred from the remote terminal 20 to the auction server 100 can include specifying how the shipping cost for the item at auction to be shipped to any potential bidder in any location in the world where shipping is available can be calculated directly on the screen that displays the auction item record 150. Preferably, the seller would be provided with a list of shippers that have a shipper server 80 in communication with the auction server 100 over the network 40 and the seller could then choose one of these shippers with whom to ship the item when the auction is completed. Alternately, if none of the said shippers can ship directly from the seller's shipping address, the seller might calculate a fixed cost to ship the item to the nearest point of contact with one of the shippers who does have a shipper server 80 in communication with the auction server 100. These shipping costs could be provided by the shipper by a link from the screen that displays the auction item record 150 to the shipper server 80 or by a link from the screen that displays the auction item record 150 to a shipper rate database 160 that has been downloaded and stored directly in the auction database 110.

Once the seller has successfully submitted an item for sale 220, a seller deposit must be submitted 230. The auction server 100 will require a seller deposit to be submitted 230 before the item will be listed for auction on the auction server 100. The deposit could be transmitted by the seller or the auction server 100 could automatically debit the seller's credit card in accordance with a pre-agreed arrangement. The seller deposit amount can be any amount that is deemed sufficient by the operator of the auction server 100, but typically would be the greater of either one half of the minimum reserve given by the seller or a fixed predetermined amount applicable to all auctions on the auction server 100.

The amount of this seller deposit could be displayed on the item auction record 150 associated with the item for sale. This allows any bidder to see the amount of the deposit on the item for sale and allows the bidder to decide whether or not the seller deposit amount is sufficient before the bidder bids on the item.

In one embodiment of the present invention the amount of the seller's deposit may be more than the standard amount depending on that seller's past history of completion of transactions on the auction service. In this embodiment, before the seller deposit is submitted 230, the auction server 100 will check the seller record 140 to ascertain his past history with respect to completion of transactions and adjust his deposit accordingly. Typically, this increase would be 30% above the typical deposit required for a seller who has never failed to complete a shipment of an item that has been successfully auctioned off. For each additional time the shipper has failed to ship a purchased item, this failure will be recorded in the seller's seller record 140 and the auction server 100 can increase the deposit the seller is required to submit 230 for a subsequent auction. This increase in the deposit can be any amount the operator of the auction server deems sufficient, i.e. 30% for each further failure to ship an item.

Conversely, if the seller's seller record 140 indicates that the seller has successfullly completed his last auction transaction, the server 100 can decrease the required deposit the seller must submit 230 if it had previously been increased due to an infraction. This decrease would typically be 30%, but any decrease deemed sufficient could be used by the auction server 100.

Once the seller deposit has been successfully submitted 230, the auction server 100 will post the item for auction 240. The auction server 100 would record all the item information provided by the seller when the item was submitted for auction 220 in an auction item record 150 associated with the item. The auction server 100 would also include any additional information required for the auction in the auction item record 150. This additional information could include: the seller identifier, any additional shipping information, the seller deposit amount submitted for the item, or any other information necessary to the auction of the item. The auction server 100 would then make the auction item record 140 available for viewing by any potential bidders.

After the item is successfully posted for auction 240, the auction on the item will begin and bidders can view the auction item record 150 for the item and submit bids on the item for the duration of the auction.

Bidder Bidding

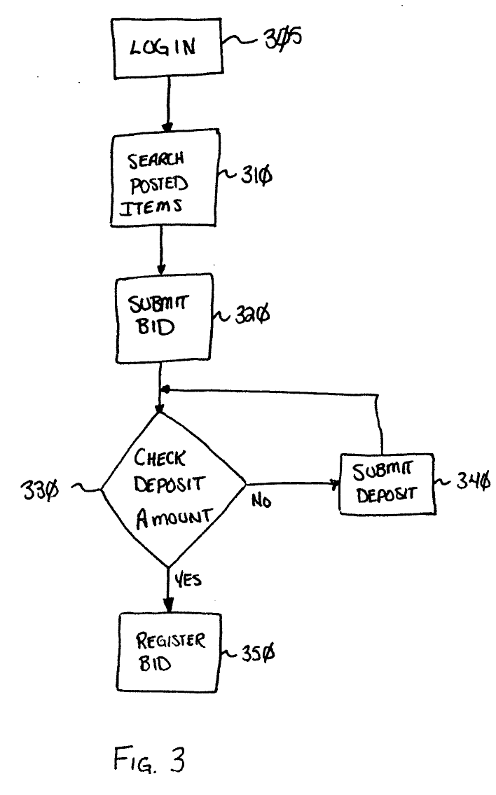

FIG. 3 illustrates the typical bidding process of the present invention. Before a bidder can bid on an item, the present invention requires the bidder to submit a deposit in the amount of the greater of a minimum amount predetermined by the auction service or a predetermined portion of the bid amount.

The method begins with the bidder accessing the auction system 10 through a remote terminal 20. Once the bidder has used the remote terminal 20 to connect to the auction server 100 over the network 40, the auction server 100 will prompt the bidder to login 305 to the auction server 100. Typically, if the bidder has already registered with the auction server 100, the login 305 involves the bidder communicating identifying information, typically in the form of his name, a credit card number or portion thereof, and an e-mail address, from the remote terminal 20 to the auction server 100. The auction server 100 can then locate the bidder record 130 in the auction database 110 that corresponds to the particular bidder using the identifying information the bidder provided to the auction server 100 during the login 305.

If the bidder has not previously registered with the auction server 100, the login 305 would typically involve the prospective bidder registering with the auction server 100. Typically, the first step of the registration process would involve the prospective bidder being shown an auction user agreement with which the bidder must confirm agreement before the bidder can continue with the registration process. This auction user agreement could be identical to the one shown to prospective sellers. For each clause of the user agreement, the new bidder could have the option of selecting an explanation for that particular clause. Typically, this could be accomplished by the registrant clicking the mouse on an onscreen “button” labeled “why”. This “button” could be located at the end of each clause. In this manner, the rationale behind unique features of the auction system 10 can be fully explained to the new bidder.

After having read, and confirmed agreement with, the auction user agreement, the bidder could continue with the registration process. The next step would involve providing certain information to the auction server 100, so that the auction server 100 can create a bidder record 130 in the auction database 110 for that particular bidder. This information could include: the bidder's name, the bidder's receiving address where items purchased on the auction service might be sent, at least one credit card number and the billing address associated with each of those credit cards, a confirmation number associated with each credit card, the bidder's email address, a screen name the bidder would like shown in conjunction with the auction, and/or any other information that might be needed to create a bidder record 130 for that particular bidder. With this information the auction server 100 could create a bidder auction record 130 for that particular bidder, and provide the bidder with a login name and password for the next time the bidder wants to log in 305 to the auction system 10.

The password for such future login process could consist of a portion of a credit card number that has been submitted in the initial login 305.

In one embodiment of the present invention, the auction server would attempt to screen out bidders (as defined by their credit card billing addresses), from re-registering under a different name to avoid the negative consequences of poor past conduct by searching the bidder records 140 for matches between the billing address for any credit card associated with any previously registered bidder or seller and any billing address for any credit card submitted by the current prospective registrant. If any match were found, the prospective registrant would be prevented from registering.

A user of the auction system 10 could be both a bidder and a seller. It is contemplated that the bidder records 130 and seller records 140 could be different portions of a merged record and when a user registers on the auction server 100 for the first time the auction server 100 can create one record for the user that includes both a bidder record 130 and seller record 140. Information in common between the bidder record 130 and seller record 140 could be only stored once and used for either bidder or seller purposes.

Once a bidder has successfully completed the login 305, that bidder can search the posted items 310 that are offered for sale on the auction system 10. The auction server 100 would make available to the bidder on the remote terminal 20 the auction item records 150 and the remote terminal 20 and auction server 100 would be configured to display the contents of the auction item record 150 to the bidder on the remote terminal 20. As described above, the posted item records 150 would typically include a picture showing the item for sale and a description of the item for sale.

When a bidder finds an item on which he would like to bid, the bidder uses the remote terminal 20 to submit a bid 320 on the item. When a bidder submits a bid 320, the auction server 100 will check the deposit amount 330 for the bidder deposit amount 135 of the bidder. The auction server 100 will check the bidder amount 330 by checking the current deposit amount 135 in the bidder's bidder record 130 on the auction database 110. If the bidder's current deposit amount 135 is equal or greater than the minimum deposit required for the bid, the auction server 100 will register the bid 350. If the bidder's current deposit amount 135 is less than the minimum bid deposit required for the bid, the auction server 100 will require the bidder to submit a bidder deposit 340 in order to bring the bidders current deposit amount 135 above the minimum level. The bidder deposit could be submitted 340 by prompting a bidder to submit a bid or it could be debited from the bidder's credit card in accordance with a pre-agreed arrangement.

Typically, the minimum deposit amount would be dependent upon the amount of the proposed bid. For example, the minimum deposit could be equal to one half of the bid that the bidder wishes to make, although it could be any amount or proportion of the bid that is deemed sufficient by the operator of the auction server 100. The minimum deposit could also be a standard amount the operator of the auction server 100 specifies as sufficient for any transaction on the auction server 100.

In one embodiment of the present invention, a bidder could be required to submit his bid 320 twice to mitigate the possibility of that bidder submitting a bid in error.

In another embodiment of the present invention, to minimize the likelihood of a seller bidding on his own auction, when a bidder submits a bid 320 on a particular item for sale, the auction server 100 could search the bidder records 130 and the seller records 140 for matches between the shipping address of the seller of the item on which the bid was submitted 320 and the receiving address of the bidder. If a match were found, the bidder could be prevented from bidding on that particular item.

In another embodiment of the present invention, the auction server 100 could notify the bidder whose bid has been prevented from being registered because the auction server 100 has found a match between the receiving address of that bidder and the shipping address of the seller of the item on which the bidder has submitted a bid and inform the bidder of the reason why the auction server 100 has failed to register his bid.

In one embodiment of the invention, the bidder could also submit a deposit 340 that is higher than the minimum amount required for the present bid. The bidder would therefore have a positive balance shown in his current deposit amount 135 of his bidder record 130. This would allow the bidder to make subsequent higher bids when the bidder is outbid by another bidder, without having to submit a new deposit each time. Also, this would allow the bidder to bid on a number of different items concurrently without having to submit a deposit each time, as long as the bidder's current deposit amount 135 is sufficient to cover the deposits for all his current bids.

In a preferred embodiment of the present invention, when a bidder submits a bid 320, the auction server 100 will check the bidder's history for past infractions. When the bidder submits a bid 320 to the auction server 100, the auction server 100 can check the bidder's bidder record 130 in the auction database 110. If the bidder's bidder record 130 indicates that the bidder has previously failed to complete the purchase of an item on which the bidder had successfully bid, the auction server 100 can increase the minimum deposit that is required from the bidder before the bidder can successfully bid 320 on an item. Typically this increase would be 30% above the typical deposit required for the bid, but any increase deemed significant could be used by the auction server 100.

For each sequential infraction shown in the bidder record 130, the auction server 100 could raise the minimum deposit by an additional amount. For example, the minimum deposit could be raised by 30% for each additional sequential time that that bidder has failed to complete a purchase or was guilty of a bid retraction.

Conversely, if the bidder record 130 indicates that the bidder has completed past transactions, the auction server 100 can decrease the deposit amount required from a bidder for every instance of the bidder successfully completing a transaction without any infractions; down to the minimum deposit amount required of any bidder on the auction service. This decrease would typically be 30%, but any decrease deemed sufficient could be used by the auction server 100.

Once the bidder submits a bid deposit 320 and the auction server 100 determines that the deposit is equal to or greater than the minimum deposit required 330, the auction server 100 will register the bid 350.

If the seller has provided potential bidders with a number of options for shipping the item once the auction is complete or the auction server 100 requires the seller to ship the item in a number of ways, the bidder will specify the shipping method that he would like when he submits a bid 320. For example, if the auction server 100 requires a seller to ship an item COD (cash on delivery) at the bidder's request, the bidder would indicate the requirement for that shipping method at that time the bidder submits the bid 320.

Preferably, if a bidder retracts his bid at any time, the deposit the bidder has provided in order to submit the bid will be forfeited. The auction server 100 would seize a bidder deposit in the event the buyer retracts his bid, to discourage a bidder from submitting an overly exaggerated bid to prevent other bidders from submitting bids on the item and then retracting this overly exaggerated bid at the last moment, only to submit a much lower newer bid. When the bidder retracts his or her bid, the auction server 100 will seize the deposit the bidder provided. The auction server 100 can use this deposit as it sees fit, but preferably the auction server 100 would detract any transactions fees from the deposit and then forward the deposit to the seller and current highest bidder in some proportion.

In one embodiment, the bidder at the time of biding 320 can specify that for the remaining duration of the auction the auction is by sealed bid. This means that the auction server 100 will not disclose the amount of any further bidscommunicate any identifying information about the bidders who are bidding to either the seller or bidder unless a bidders decides to disclose his identity to either the seller or another bidders at his discretion.

In one embodiment of the invention, the bidder is able submit a bid 320 for an amount that is between the highest bid and the second highest bid, in the event that the person who submitted the highest bid fails to complete the transaction after winning the auction.

Completing the Auction Transaction

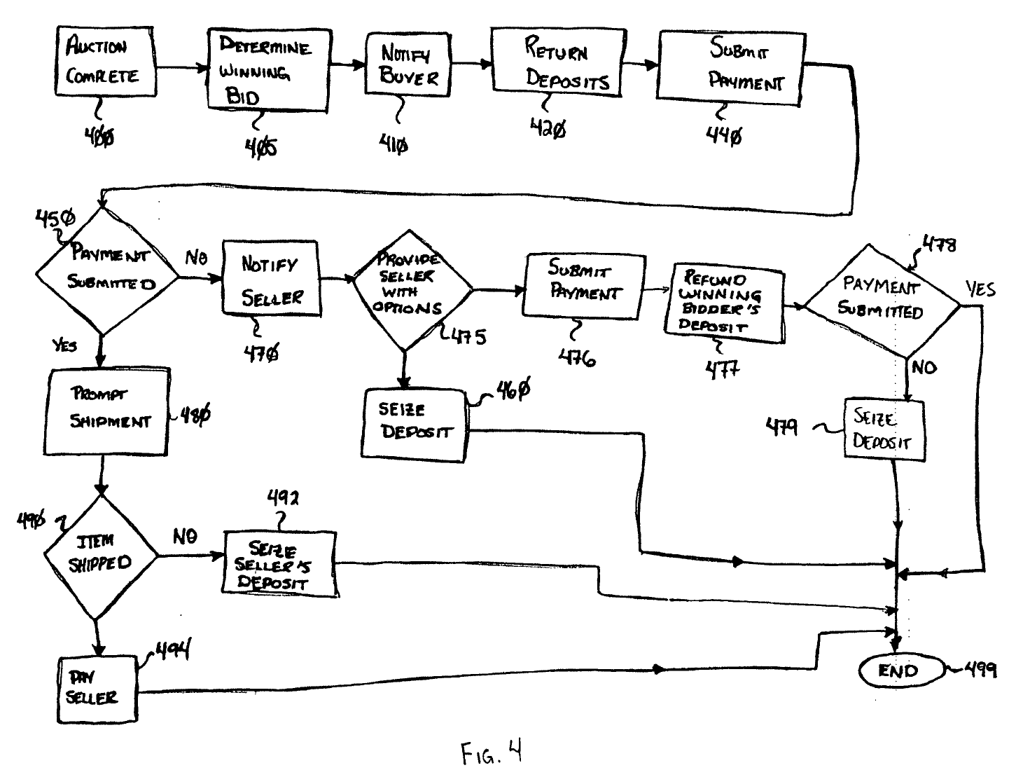

The auction system 10 will conduct each auction. The auction could be conducted in any known format. Each auction of an item will run for a specified duration and bids from different bidders will be received and recorded for each auction. Once the duration of the auction is over, the bidder that won the auction will be determined. FIG. 4 illustrates a flowchart of a method for completing the auction transaction in accordance with the present invention after the auction has been won.

When an auction for an item reaches its closing date and time, the auction for the item will be complete 400. After the auction is completed 400, the auction server 100 will determine the winning bid 405 and identify which of the bidders submitted the winning bid. Typically, this is done by the auction server 100 determining the highest bid and then determining the bidder who submitted the highest bid.

Once the auction is completed 400 and the winning bidder 405 is determined, the auction server 100 will notify the winning bidder 410. Typically, the winning bidder would be notified 410 by e-mail or by a message directly to the bidder terminal 20.

Next, the auction server 100 could return the deposits 420 to all of the bidders except for the bidders that have opted to leave an ongoing deposit, the highest bidder and the second highest bidder. The auction server 100 could return the deposits 420 by crediting the credit cards of the bidders.

The auction server 100 would then have the bidder submit a payment 440 within a predetermined time. Typically, the payment would be submitted 440 by the auction server 100 debiting the credit card of the winning bidder. The payment submitted 440 will be an amount that when added to the deposit that was already submitted by the bidder, will total the winning bid. Additionally, the payment submitted 440 could also include any transaction fees associated with this transaction plus any shipping cost associated with the transaction.

The auction server 100 will then check, after the predetermined time, to see if the payment 450 has been submitted. If the auction server 100 checks to see if the payment was submitted 450 and the payment was not submitted, the auction server 100 will notify the seller 470 of this failure, and provide the seller with the option 475 to sell his item to the bidder with the second highest bid on that auction.

If the seller chooses the option of selling the item to the second highest bidder 475, the auction server 100 will give the second highest bidder a predetermined amount of time to submit payment 476 for the item and will refund the highest bidder's deposit 477. The payment can be submitted 476 by the second highest bidder by the auction server 100 charging one or more of the credit cards of the second highest bidder.

The auction server 100 will then check to determine whether the payment by the second highest bidder was successfully paid 478. If when the auction server 100 checks to see if the payment was successfully submitted 478 and if the payment was successfully submitted, the auction server 100 will treat the auction transaction as completed 499.

If, for any reason, the auction server 100 was not able to receive payment 478, i.e. charge this amount to one or more of the credit cards of the second highest bidder within a preset time, the deposit of the second highest bidder will be seized 479 by the auction server 100. The second highest bidder's deposit could then be divided in a predetermined way between the seller and the auction service minus any transaction fees incurred by the auction service for this transaction and if the payment was successfully submitted, the auction server will then prompt the server to ship the item 480 and the process will proceed as if the highest bidder had completed submission of the payment except the seller will be prompted to ship to the receiving address of the second highest bidder. The auction transaction will then be treated as completed 499.

If the seller does not choose the option of selling the item to the second highest bidder 475, the auction server 100 will seize the winning bidder's deposit 460 and this deposit will be dealt with in a predetermined way. Typically, the seized deposit will be divided between the seller and the second highest bidder minus any transaction fees incurred by the auction service for this process. The deposit, typically, is divided between the second highest bidder and the seller as compensation to them for time invested by them in the failed transaction. At this point the deposit of the second highest bidder would be returned.

At this point, the auction server 100 could simply treat the auction transaction as completed 499.

If at the step where the auction server 100 checks if the winning bidder has submitted the proper payment 450 and the winning bidder has successfully submitted the proper payment, the auction server 100 will prompt the seller to ship the item 480 to the to the receiving address that the bidder has provided to the auction server 100 during the login process. Optionally, if the seller is shipping his item with a shipper that has a shipper server 80 in communication with the auction server 100 the auction server 100 could opt to provide the receiving address of the bidder only to the shipper server 80 and not to the seller. This option would maintain the privacy of the bidder with respect to the seller, and perhaps prevent future unwanted communications from the seller to the bidder.

The auction server 100 will then, after a predetermined amount of time, check whether the seller has shipped the item 490. If the seller specified a shipper that has a shipper server 80 in communication over a network 40 with the auction server 100, the shipper server 80 can simply notify the auction server 100 when the auction item ships. Alternately, if the shipper that is being used does not have a shipper server in communication with the auction server 100, that shipper could contact the auction service by any available means, to notify the auction service that the item has been shipped 490.

If the auction server 100 checks to see if the item has been shipped 490 and it has been. The auction server 100 will forward payment for the item to the seller 494. This payment could be made by crediting one of the credit cards of that seller. After the auction server 100 provides the payment to the seller 494, the auction server 100 will treat the auction transaction as completed 499.

If the auction server 100 checks whether the seller has shipped the item 490 and determines the seller has failed to ship the item within the specified period, the seller will forfeit his or her deposit and the auction server 100 will seize the seller's deposit 492 as a penalty for non-performance. This deposit can either be kept by the auction service or it can be divided in some preset fashion between the bidder and the second highest bidder minus any transaction fees as a compensation for the failed purchase. The auction transaction will then be treated as being ended 499 by the auction server.

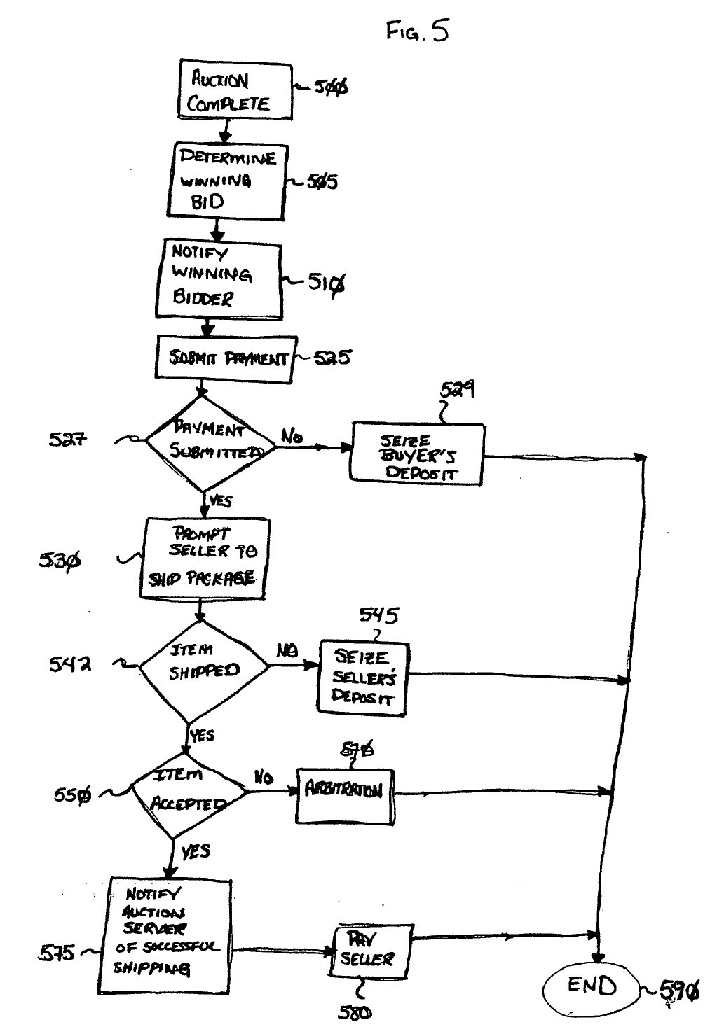

FIG. 5 illustrates a flow chart of a method for completing the auction transaction after the auction has been won where the bidder has the requested the item shipped be shipped by COD (cash on delivery). Again, the auction of an item will run for a specified duration and bids from different bidders will be received and recorded for each auction. Once the duration of the auction is over, the bidder with the highest bid will be deemed the winner of the auction.

After the auction has reached the closing data and time and the auction is completed 500, the auction server 100 will typically determine the bidder who won the auction 505 by determining the highest bid and then determining the bidder who submitted the highest bid.

The auction server 100 will notify the winning bidder 510 who has won the auction that they have purchased the item that was the subject of the auction. The auction server 100 will notify the bidder 510 by sending a message to the bidder computer 20 informing the bidder who submitted the highest bid, that they have won the auction.

The auction server 100 would have the winning bidder submit payment 525. This could be done in any standard manner but would typically be achieved by charging one of the credit cards of the bidder an amount that when added to the deposit already in possession of the auction service, would total the winning bid amount plus the cost of shipping the purchased item COD plus any transaction fees associated with this transaction. The auction server 100 will then check to determine whether or not the payment was successfully submitted 527.

If the payment is not successfully submitted 527, the auction server 100 will seize the buyer's deposit 529 and the auction transaction will be considered completed 590.

If the payment was successfully submitted 527, before a preset time for the bidder to complete the payment has elapsed, the auction server 100 will prompt the seller to ship the item 530. The auction server 100 notifies the seller as to what the highest bid was, and the seller is provided with the receiving address of the bidder by the auction server 100 in the prompt to ship the package COD 530. Alternatively, if the seller has specified a shipper who has a shipper server 80 in communication with the auction server 100 over the network, the auction server 100 can communicate the bidder's shipping information directly to the shipper server 80. The seller will then have a specified amount of time to ship the item COD using the specified shipper.

The auction server 100 will then check to see if the seller shipped the item COD 542 within the specified time. Typically, the auction server 100 would contact the shipper specified by the seller in registering the item for the auction and check to see if the item was shipped within the specified time period, i.e. 10 days. The shipper could be contacted by any conventional means such as telephone, fax, etc., but preferably the auction server 100 would be in communication with the shipper's shipper server 80 over the network 40. The auction server 100 would then automatically request the shipper server 80 to confirm whether or not the shipper has shipped the item by the end of the specified period and the shipper server 80 could either confirm or deny the item was shipped. Alternately, the shipper server 80 could be programmed to automatically inform the auction server 100 when the item is shipped COD, and if this notification is received by the auction server 100 within the preset time for the seller to ship, the rest of the transaction could proceed.

If the auction server 100 checks whether the seller has shipped the item 542 and determines the seller has failed to ship the item within the specified period, or if the shipper server 80 is programmed to automatically inform the auction server 100 when the item has been shipped by the seller, and that confirmation is not received by the auction server 100 within the preset time the seller's deposit will be forfeit and the auction server 100 will seize the seller's deposit 545 as a penalty for non-performance. This deposit can then either be kept by the operator of the auction server 100 or it can be given to the winning bidder as a compensation for the failed purchase. Optionally, after the auction server 100 removes a transaction fee, a portion of the deposit amount can be given to the highest bidder and the remaining amount given to the second highest bidder. The auction server 100 will then treat the auction transaction as completed 590.

Once the item has been shipped to the bidder COD, the bidder will be able to choose whether to accept or refuse the item 550. If the bidder accepts the item, the shipper or shipper server 80 will notify 575 the auction server 100 which will then provide the seller with the proper payment 580 for the item sold. The auction server 100 could provide the seller with the proper payment 580 by crediting one or more of the credit cards of the seller the amount of the highest bid minus any transaction fees for this transaction. Once the payment to the seller is successful, the auction transaction will be completed 590.

If the bidder refuses the item at this step 550, the refused item will not be returned to the seller, but will be sent to a receiving point manned by one or more agents of the auction service. After inspection of the contents of the shipment, this agent or agents will make a binding arbitration 570 ruling as to the validity of the rejection by the bidder, and the selling price of the item and the deposit of the seller which are in possession of the auction service will be divided and allocated to the bidder and seller minus any fees associated with this arbitration process, in accordance with this ruling. The shipped item will then be returned to the seller or the bidder depending on the arbitration 570 ruling.

At this point, the transaction will be considered complete 590.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A system for conducting online auctions over a computer network, the system comprising:
an auction server, the auction server containing:
a bidder database containing at least one bidder record associated with a corresponding bidder, wherein each bidder record includes a deposit amount which represents the amount of a deposit paid by that bidder; and
an item database containing at least one item record associated with an item to be auctioned; and
at least one remote terminal operatively connected to the auction server over the network, each remote terminal operative to allow a bidder to transmit a bid to the auction server;
wherein the auction server, in response to receiving a bid from a remote terminal by a bidder during an auction of an item, checks the deposit amount in the bidder record associated with that bidder against a minimum required deposit in respect of the item being auctioned and if it is determined that a sufficient deposit has been paid by the bidder the auction server registers the current bid.

2. The system of claim 1 wherein upon determining that the deposit amount does not satisfy the minimum required deposit amount in respect of the item being auctioned, the auction server transmits a request to the remote terminal for the current bidder to submit a further deposit which would increase the deposit amount in the corresponding bidder record.

3. The system of claim 1 wherein the minimum required deposit amount in respect of the item being auctioned is approximately half the amount of the current bid.

4. The system of claim 1 wherein the minimum required deposit amount in respect of the item being auctions is predetermined before the auction is started.

5. The system of claim 1 wherein the bidder records include a past infraction history and wherein when a bid is received by the auction server, the auction server checks the past infraction history and if the past infraction history indicates past auction rule infractions by the current bidder, the minimum required deposit amount in respect of the item being auctioned is increased in respect of that bidder.

6. The system of claim 5 wherein the minimum required deposit amount in respect of the item being auctioned is increased for each past infraction indicated by the past infraction history.

7. The system of claim 5 wherein the minimum required deposit amount in respect of the item being auctioned is increased by approximately one third for each past infraction indicated by the past infraction history in respect of the bidder.

8. The system of claim 7 wherein a past infraction is removed from the past infraction history for each successfully completed transaction.

9. The system of claim 1 wherein a bidder must complete a login at the remote terminal before the auction server will accept bids placed by that bidder from the remote terminal.

10. The system of claim 9 wherein the login comprises the current bidder transmitting identifying information from one of the remote terminals to the auction server and the auction server using the identifying information to access the bidder record associated with the current bidder.

11. The system of claim 1 wherein a bidder record is created by a potential bidder completing a registration, the registration comprising transmitting identifying information from one of the remote terminals to the auction server.

12. The system of claim 11 wherein the registration further comprises the auction server comparing the identifying information submitted by the potential bidder to existing bidder records in the bidder database, wherein the registration will be refused if corresponding information is found in an existing bidder record.

13. The system of claim 1 wherein the deposit provided by a bidder is seized if the current bidder retracts the current bid, by reducing the deposit amount in the corresponding bidder record by the minimum required deposit amount in respect of the item being auctioned.

14. The system of claim 1 wherein if the winning bidder in an auction fails to provide a full payment for the item the deposit provided by the winning bidder is seized by reducing the deposit amount in the corresponding bidder record in an amount to satisfy the winning bid.

15. The system of claim 1 wherein the deposit amount of a bidder record is used in relation to a single item being auctioned and wherein upon the completion of the auction of that item, if the bidder corresponding to that bidder record does not have the winning bid in the auction, then the deposit is refunded to the bidder.

16. The system of claim 1 wherein the deposit amount of a bidder record is used in relation to multiple item auctions and for each submitted bid, the deposit amount is reduced by the minimum required deposit amount.

17. A method of conducting online auctions over a computer network, where remote terminals of potential bidders are used to access an auction server computer, the method comprising:
receiving a deposit from a current bidder and storing the amount of the deposit as a deposit amount;
receiving a current bid from the current bidder on an item being auctioned;
in response to receiving the current bid, checking the deposit amount of the current bidder; and
if the deposit amount of the current bidder indicates at least a minimum required deposit amount in respect of the item being auctioned, accepting and registering the current bid; and
upon the occurrence of a predetermined auction closing condition, completing the auction of the item in accordance with auction rules based on the accepted bids in respect of the item.

18. The method of claim 17 wherein the minimum required deposit amount in respect of an item being auctioned is approximately half the amount of the current bid.

19. The method of claim 17 wherein the minimum required deposit amount in respect of an item being auctioned is predetermined before the auction starts.

20. The method of claim 17 wherein if the current bidder has past infractions of the auction rules the minimum required deposit amount in respect of an item being auctioned is increased in respect of that bidder.

21. The method of claim 20 wherein the minimum required deposit amount in respect of an item being auctioned is increased in respect of a particular bidder for each previous past auction rules infraction by that bidder.

22. The method of claim 17 wherein the current bidder must complete a login at a remote terminal before the auction server will accept bids transmitted by that bidder from the remote terminal.

23. The method of claim 17 comprising seizing the deposit by reducing the deposit amount by the minimum required deposit amount in respect of the item being auctioned if a bidder retracts an otherwise acceptable or previously accepted bid.

24. The method of claim 17 wherein upon completion of the auction of an item the winning bidder is provided with a predetermined time period to submit a payment in respect of the auction and if the payment is not submitted within the predetermined time period, the deposit is forfeited in at least the amount of the minimum required deposit amount in respect of the item.

25. The method of claim 17 wherein upon completion of the auction of an item the winning bidder is provided with a predetermined time period to submit a payment in respect of the auction and if the payment is not submitted within the predetermined time period the seller is provided with the option of choosing another bid as the winning bid and the deposit of the original winning bidder is refunded.

26. A system for conducting online auctions over a computer network, the system comprising:
an auction server containing an item database containing at least one item record associated with an item to be auctioned; and
at least one remote terminal operatively connected to the auction server over the network, each remote terminal operative to allow a seller to send the particulars of an item to be auctioned, including submitting a seller deposit in respect of that item, to the auction server resulting in the creation of an item record in the item database;
wherein during an auction of an item from the item database by the auction server, the seller deposit amount in respect of the item being auctioned is displayed to potential bidders using remote terminals to access the auction server to participate in the auction.

27. The system of claim 26 wherein the seller deposit must meet a predetermined minimum threshold before the auction server will post the current item for auction.

28. The system of claim 26 wherein a seller must complete a login at a remote terminal before the auction server will accept the posting of an item to the item database by the seller.

29. The system of claim 28 wherein the login comprises the current seller transmitting identifying information to the auction server and the auction server using the identifying information to access a seller record associated with the current seller.

30. The system of claim 26 wherein a seller record is created by a potential seller completing a registration, the registration comprising the seller transmitting identifying information from one of the remote terminals to the auction server.

31. The system of claim 30 wherein the registration further comprises the auction server comparing the identifying information submitted by the potential seller to existing seller records, wherein the registration will be declined if corresponding information is found in an existing seller record.

32. The system of claim 26 wherein upon completion of an auction of an item from the item database the seller deposit is seized if the seller fails to ship the item to the winning bidder within a predetermined time period.

33. A method of conducting online auctions over a computer network, where remote terminals of potential bidders and potential sellers are used to access an auction server computer, the method comprising:
the auction server receiving from a current seller a posting of an item to be auctioned and a seller deposit and creating an auction item record associated with the item and storing a seller deposit amount in the auction item record;
allowing potential bidders using remote terminals to access the current auction item record and display the seller deposit amount;
conducting the auction in accordance with a set of auction rules; and upon completion of the auction, if the current seller fails to ship the item to the winning bidder within a predetermined period of time, seizing the seller deposit.

34. A method of conducting auctions over a network, where remote terminals of potential bidders and potential sellers are used to access an auction server computer, the method comprising;
the auction server receiving a posting of an item to be auctioned and a seller deposit and creating an auction item record associated with the item and storing a seller deposit amount in the current auction item record;
allowing a potential bidder using a remote terminal to access the auction item record associated with the item and viewing the seller deposit amount;
the auction server receiving a current bid on the item from a current bidder and in response to receiving the current bid, checking a bidder deposit amount in a bidder record associated with the current bidder and registering the current bid if the bidder deposit amount is at least a minimum required deposit amount in respect of the item being auctioned; and
upon an occurrence of a predetermined auction closing condition, completing the auction of the item in accordance with a set of auction rules based on the accepted bids in respect of the item.

35. The method of claim 34 wherein the minimum required deposit amount in respect of an item being auctioned is approximately half of the current bid.

36. The method of claim 34 wherein the minimum required deposit amount in respect of an item being auctioned is predetermined before the auction starts.

37. The method of claim 34 further comprising seizing the seller deposit if the seller fails to ship the item to the winning bidder within a predetermined time period from the completion of the auction.

38. The method of claim 34 further comprising seizing the deposit of a bidder who retracts an otherwise acceptable or accepted bid.

39. The method of claim 34 wherein upon completion of the auction of an item the winning bidder is provided with a predetermined time period to submit a payment in respect of the auction and if the payment is not submitted within the predetermined time period, the buyer deposit is forfeited in at least the amount of the minimum required deposit amount in respect of the item.

40. The method of claim 34 wherein upon completion of the auction of an item the winning bidder is provided with a predetermined time period to submit a payment in respect of the auction and if the payment is not submitted within the predetermined time period the seller is provided with the option of choosing another bid as the winning bid.

41. The method of claim 34 comprising at the end of the auction, the auction server selecting a winning bid transmitted by a winning bidder and the current seller shipping the item to the winning bidder, wherein if the winning bidder upon receiving the item refuses to accept the item, the item is transported to a receiving point and an arbitration is conducted on the sufficiency of the refusal of the winning bidder.
